(19) United States
(12) Patent Application Publication
(10) Pub. No.: US 2013/0066694 A1
(43) Pub. Date: Mar. 14, 2013

(54) Online Auction System with Random Rebate

(71) Applicants: Christopher M. Lifka, Jacksonville, FL (US); Sharon L. Lifka, Jacksonville, FL (US)

(72) Inventors: Christopher M. Lifka, Jacksonville, FL (US); Sharon L. Lifka, Jacksonville, FL (US)

(21) Appl. No.: 13/231,325

(22) Filed: Sep. 13, 2011

(51) Int. Cl. G06Q 30/00

(52) U.S. Cl. 705/14.14

(57) ABSTRACT

An online auction system with a random rebate includes a computer having a processor, memory storing programming, and input, the computer being in network communication with the internet. The processor executes programming to receive auction item, rebate range, pool closure time, and auction time data from the computer input. The processor receives bidder registration data until pool closure, a predetermined fee, and bids from registered bidder until auction time expiration. The processor determines the highest bidder upon auction time expiration and notifies the highest bidder to make payment. A random rebate percentage is determined and sent to the bidder. Operation of the auction system enables a seller to receive a predetermined amount of auction registration fees and a winning bid amount less the random rebate. A buyer is able to purchase an auction item for less than market value and also receive a randomly assigned rebate.

### BACKGROUND OF THE INVENTION

This invention relates generally to online auctions and, more particularly, to an online auction that awards a randomly determined rebate to a winning bidder from a closed pool of bidders having each paid a predetermined participant fee.

An auction is a well known public or private sale in which an item is sold to the highest bidder. This form of sale is frequently used to sell the goods of a deceased person at an estate sale, to sell expensive artwork or other highly valuable assets, or even to sell donated items to raise money for charitable causes.

With the growing use of the internet as a tool for commerce, online auctions such as eBay® have become very popular for buying and selling goods. Although internet auction sites are useful to enable sellers to find buyers for what some may think are impossible to sell items, e.g. outdated or even broken technology, online auctions often enable buyers to obtain products at below market value. In other words, a seller may sell a product at a reduced cost but still be satisfied merely to have sold the product. From a seller's perspective, online auctions are not usually seen as a means for a seller to make a substantial profit on any single sale. From a buyer's perspective, a buyer may be very satisfied to win the auction and obtain a product at any price that is below what would be considered fair market value, especially since the online sales transaction may not be subject to sales tax.

Therefore, it would be desirable to have an online auction system in which a buyer (i.e. the highest bidder) may be awarded a substantial rebate by the auction administrator at the conclusion of the auction transaction. Further, it would be desirable to have an online auction system in which the seller receives a bidder registration fee from each bidder received into a closed bidder pool. In addition, it would be desirable to have an online auction system in which revenue from the bidder registration fees and from the highest bid will be substantially in excess of monies invested by the auction sponsoring the registration and actual cost of the auction item. In this way, a winning bidder may receive the sponsored goods at a randomly rebateed price and a seller may generate significantly more revenue than a traditional sale transaction.

### SUMMARY OF THE INVENTION

An online auction system with a random rebate includes a computer having a processor, memory configured to store programming, and input, the computer being in network communication with the internet. The processor executes programming to receive auction item, rebate range, pool closure time, and auction time data from the computer input. The processor receives bidder registration data until pool closure, a predetermined fee, and bids from registered bidders until auction time expiration. The processor determines the highest bidder upon auction time expiration and notifies the highest bidder to make payment. A random rebate percentage is applied and sent to the bidder as a rebate. It is understood that the possibility of a bidder receiving a substantial rebate off of the winning bid, say 75%, will be a powerful inducement to participation in the auction. Operation of the auction system enables a seller to receive a predetermined amount of auction registration fees and a winning bid amount less the random rebate. A buyer is able to purchase an auction item for less than market value and also receive a randomly assigned rebate.

Therefore, a general object of this invention is to provide an online auction system that establishes a limited pool of registered bidders that offers a random rebate to the winning bidder according to a process that optimizes revenue to the seller and rebates to the buyer.

Another object of this invention is to provide an online auction, as aforesaid, in which each registered bidder pays a predetermined fee for the privilege of participating in a product auction.

Still another object of this invention is to provide an online auction, as aforesaid, in which an auction administrator determines how many bidders will be allowed into an auction pool, the amount of the auction fee, the item to be auctioned, and a range of rebate percentages to be randomly selected from upon expiration of the auction.

Yet another object of this invention is to provide an online auction, as aforesaid, that requires the winning bid to be paid into the auction system prior to randomly assigning a rebate and sending to the winning bidder the amount of the rebate.

A further object of this invention is to provide an online auction, as aforesaid, is to enable the seller/auction administrator to collect revenues from pool registration fees and from the highest bid.

A still further object of this invention is to provide an online auction, as aforesaid, is to enable a buyer to potentially purchase the auction item for less than market value and then receive an additional randomly applied rebate.

Other objects and advantages of the present invention will become apparent from the following description taken in connection with the accompanying drawings, wherein is set forth by way of illustration and example, embodiments of this invention.

### BRIEF DESCRIPTION OF THE DRAWINGS

FIG. 1 is a flowchart illustrating a setup process for an online auction system with random rebate according to a preferred embodiment of the present invention;

FIG. 2 is a flowchart illustrating a bidder pool acquisition process according to the online auction system;

FIG. 3 is a flowchart illustrating an unfilled bidder pool process according to the online auction system;

FIG. 4 is a flowchart illustrating the main auction operation process according to the online auction system; and

FIG. 5 is a block diagram illustrating the physical and electrical components of the online auction system.

### DESCRIPTION OF THE PREFERRED EMBODIMENT

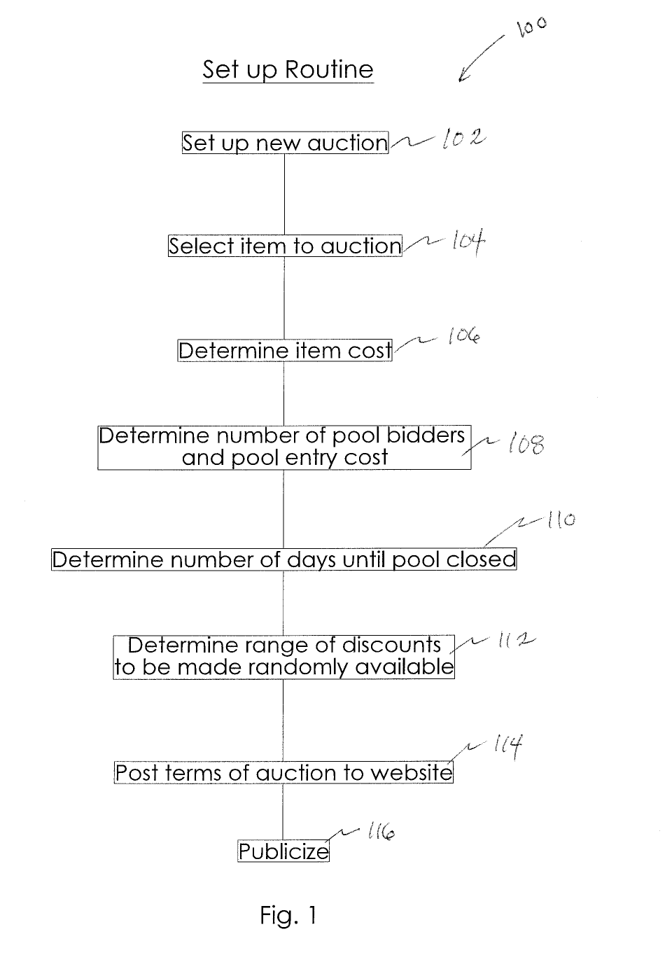

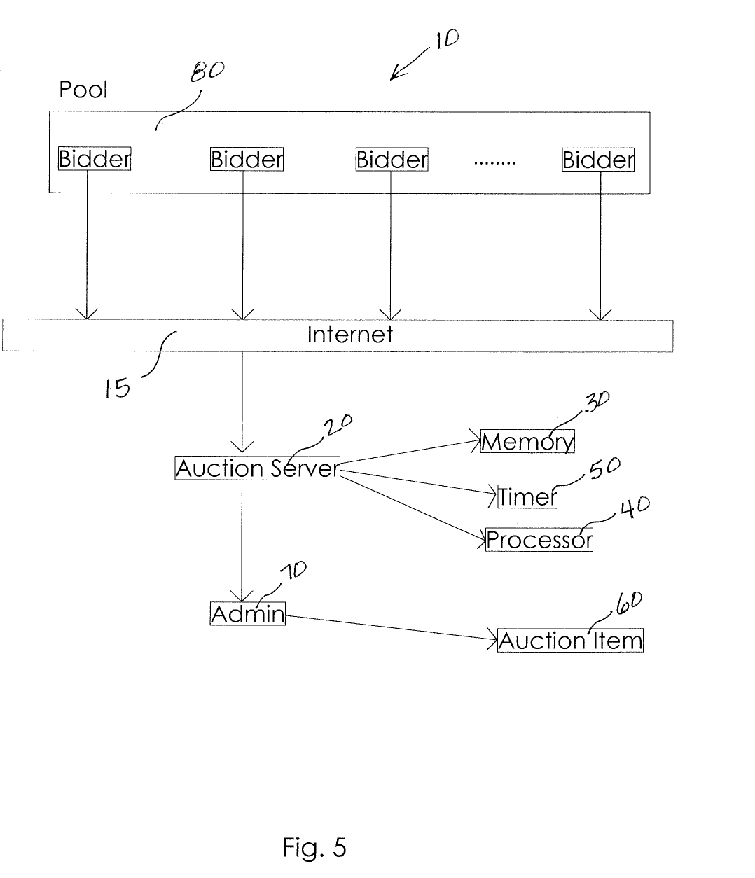

An online auction system with random winner rebate will now be described in detail with reference to FIGS. 1 to 5 of the accompanying drawings. The online auction system 100 includes a computer 20 electrically connected to a computer network 15, the computer 20 including memory 30 configured to store programming and a processor 40 configured to execute the programming as discussed in detail below.

Preferably, the computer 20 is a network server that is configured to connect to a wide area computer network 15 such as the Internet to facilitate communication with computer users throughout the world. The computer's memory 30 includes data structures configured to store programming instructions as well as to store data specific to online auctions and bidder registrations as will be described below. More particularly, data to be recorded relative to an auction may include a chosen auction item 60 having a unique identifier, an auction item description, an auction item picture, an auction item cost, pool closure time data, and auction time data. Preferably, the computer 20 includes an input device (not shown), such as a keyboard, mouse, scanner, or the like, by which an auction administrator 70 may select various initial or predetermined parameters and input them into the computer 20 for storage in memory 30.

The computer 20 may also include a timer 50 in electrical communication with the processor 40 that is configured to measure a predetermined amount of days, hours, and minutes in which bidders are permitted to register for an auction using a computer connected to the auction computer 20 via the internet. In addition, the timer 50, when actuated, may measure a predetermined amount of time that the auction is permitted to operate before a highest bidder is declared the winner.

The components of the online auction system 100 will be best understood by a description of system's logic and execution of programming with reference to the exemplary embodiment shown in the drawings. An administrator of the system 100 is able to enter various parameters that will control operation of the system 100 using an input (not shown) electrically connected to the computer 20, e.g. a keyboard, mouse, touch screen, or the like. FIG. 1 illustrates a setup routine to prepare an auction process. With reference to FIG. 1, the administrator 70 begins to set up a new auction at block 102 by selecting 104 or inputting an item to auction, i.e. the “auction item” 60. At block 106, the administrator determines the cost of the item, which will become important later in determining a profit margin. The administrator 70 may also input information regarding a description of the auction item, a picture of the auction item, and an identifier (i.e. product number) by which the auction item may be uniquely identified. It is understood that the information regarding aspects pertaining to the auction item may be referred to collectively as auction item data.

At block 108, the administrator 70 may determine the number of bidders that will be received into the bidder pool 80 and the cost per bidder registration. In other words, only a maximum number of bidders will be allowed to participate in a given auction and a maximum amount of revenue will be generated through bidder registration fees. At block 110, the administrator 70 may determine the number of days (or longer) that the pool will remain open for reception of bidder registrations. Upon expiration of this time, the pool is closed and the auction may begin as will be further discussed later. Although not specifically shown, it is understood that the length of time for the auction to operate, i.e. for bids to be received, may be set by the administrator and is referred to herein as an “auction time.”

An important step is illustrated at block 112. Namely, the administrator 70 determines a range of possible rebates from which an auction rebate will be chosen after a winning bid is declared in the normal course of the auction. The particular range of rebates, say 25% up to 75% may be used to induce bidders to participate in the auction. The rebate range is stored in memory 30 from which a single “winning rebate” will be selected after a winning bid is determined and payment received at the end of the auction time. Once the auction is prepared as described above, its terms may be posted on the auction website, as indicated at block 114. At block 116, the auction may also be advertised, such as on the auction website, on other websites, or even on radio or television.

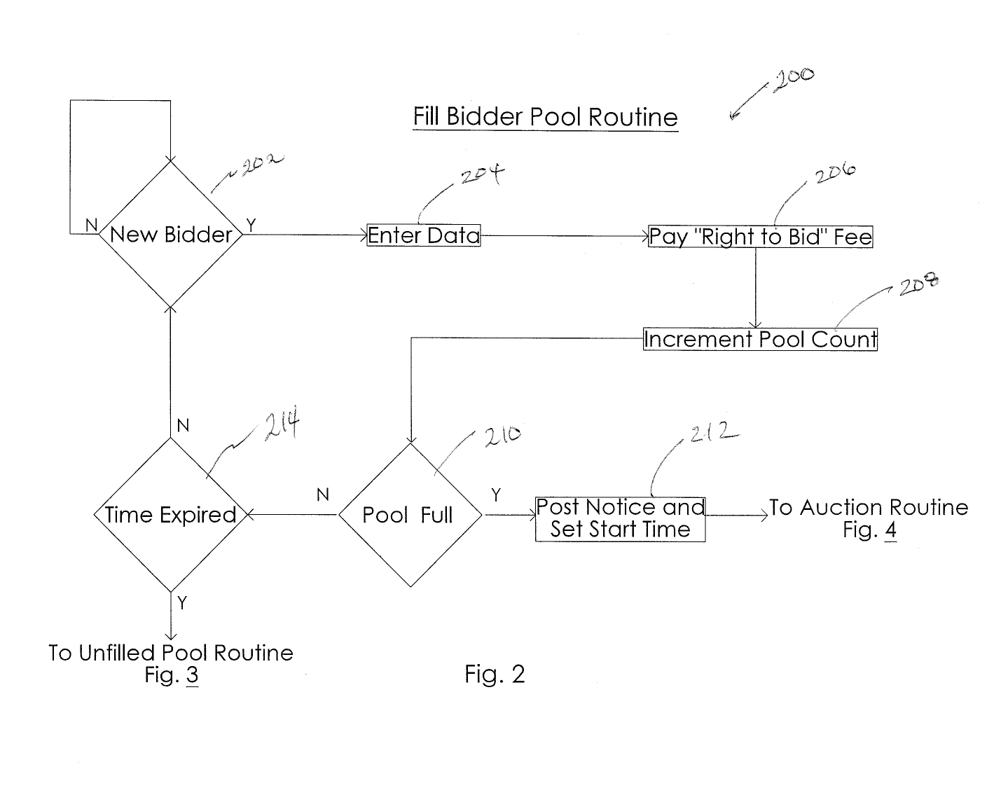

FIG. 2 illustrates a routine or process 200 for filling a bidder pool 80. In other words, persons desiring to participate in the online auction may access the auction computer 20 via the internet and, according to auction data, may register their information and pay the requisite participation fee. More particularly, at step 202, the processor 40 in the auction computer 20 executes respective programming to determine if a new bidder desires to register. If so, the process 200 proceeds to step 204. If not, control is passed again to step 202 and the process waits for a new bidder. At step 204, the new bidder is asked to enter data, such as name and contact information and this data is stored in memory 30 for use at a later time, such as if that bidder is determined to be a winner. The process 200 then proceeds to step 206 in which the new bidder is required to pay the predetermined bidder registrationn fee associated with the auction data input by the administrator 70. The process 200 then proceeds to step 208 where the pool count is incremented by one.

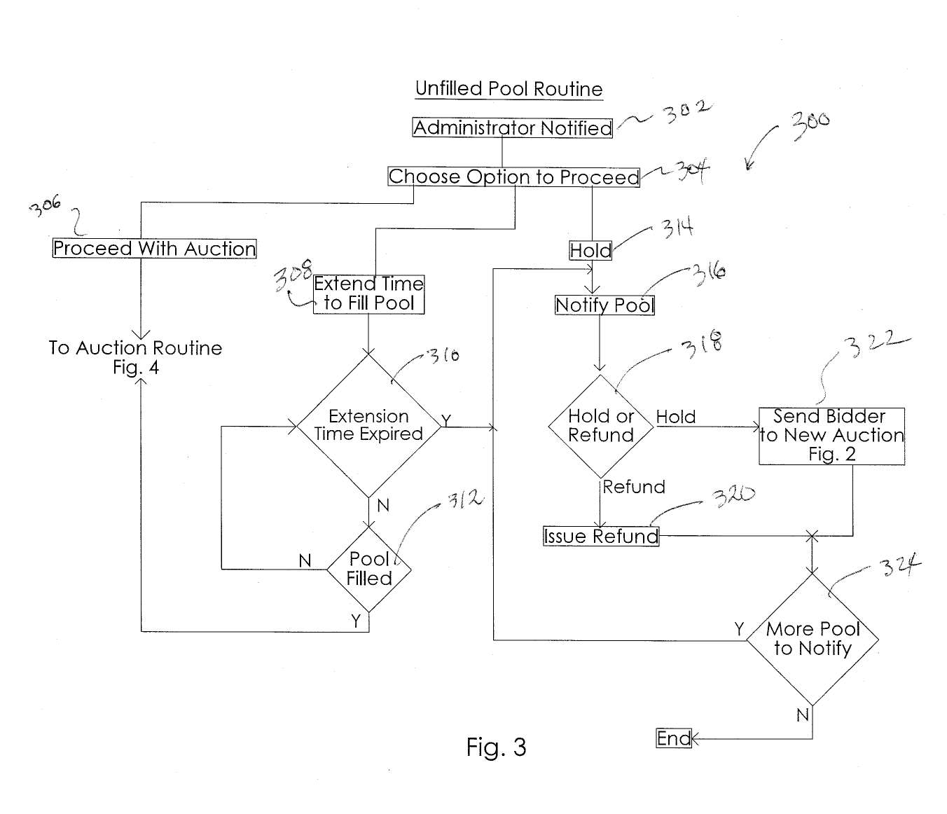

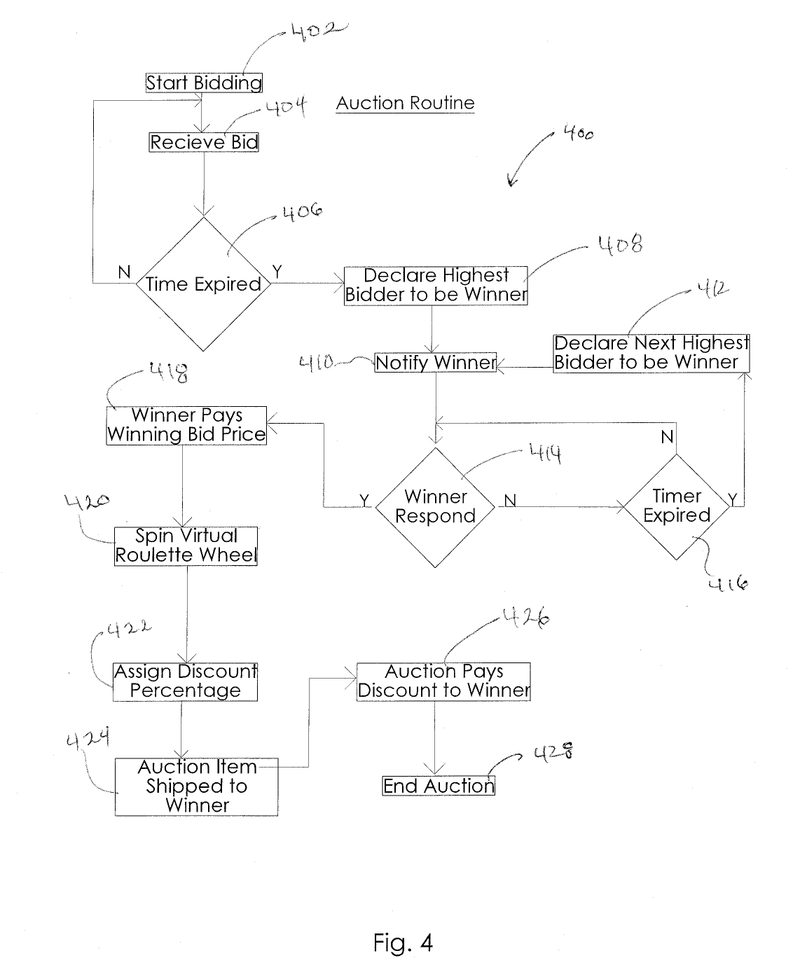

The process 200 then proceeds to step 210 where the processor 40 executes programming to determine if the pool has reached the predetermined number of bidders. If so, the process 200 proceeds to step 210 in which a notice and start time of the auction may be posted, such as on the auction website, and then control is delivered to the auction process 400 shown in FIG. 4. However, if the pool is not full, then the process 200 proceeds to step 214 in which the process determines if the pool closure time associated with pool closure data has expired. If so, the process 200 passes control to the unfilled pool process 300 illustrated in FIG. 3. Otherwise, the process 200 returns to step 202 and the process cycles again. In summary, the process to fill a bidder pool according to predetermined parameters only passes control to the actual auction operational routine if the pool is filled prior to expiration of the pool closure time. Otherwise, bid registrations continue to be received until the pool closure time expires and then, if the pool is still not filled, control is passed to the unfilled pool process 300, as will be described below. It is understood that the computer 20 of the auction system 10 includes or is electrically connected to the timer 50 that, when actuated, is configured to monitor an elapsed time for the pool to be closed.

The unfilled pool process 300 is illustrated in FIG. 3. At step 302, the administrator 70 is notified that the pool has not been completely filled as of the predetermined closure time initially set by the administrator 70 during setup. The process 300 then proceeds to step 304 in which the administrator 70 is presented with options of how the auction may proceed or be canceled altogether. The option selection process is illustrated in FIG. 3 as a decision tree and may in practice be presented to the administrator 70 as touch screen options on a display or as a list of choices to select from. One option is for the administrator to choose to allow the auction to proceed with the number of bidders registered into the pool as of the time of expiration, as indicated at block 306. This may be deemed a good option if the pool was almost completely filled as of closure of the pool filling time or if sufficient auction registration/participation fees are deemed sufficient to justify proceeding. If the option to proceed with the auction is selected by the administrator 70, control is transferred to the auction process 400 illustrated in FIG. 4.

Otherwise, the administrator 70 may choose to extend the time to fill the pool, as indicated at block 308. This may be deemed a good choice by the administrator 70 if the pool is close to being filled or if the original time to fill the pool was only a brief time thus making an extension not considered unreasonably long. At step 310, the processor 40 determines whether the extended time to fill the pool has expired and, if not, proceeds to step 312. At step 312, the processor 40 determines if the pool is filled and, if so, transfers control to process 400 so that the auction may begin in due course. However, if the extended time to fill the pool has expired and the pool is still not filled, then the administrator may consider his options again, i.e. to proceed with the auction with the pool as is or yet a third option.

A third option available to the administrator 70 is to place a “hold” on the auction, as illustrated at block 314. If this action is selected, the process proceeds to step 316 at which each registered bidder in the pool 80 is notified. At step 318, the processor 40 determines if a notified bidder agrees to hold—either wait for the auction to be restarted later or hold for a next auction to be initiated—or to request a refund of a paid bidder registration fee. If a refund is requested, then the processor 40 directs a refund to be issued at step 320. If a hold is requested, then control is returned at block 322 to process 200 relative to the respective bidder to fill a pool for the auction. Alternatively, a bidder may elect to be automatically placed in a bidder pool the next time this particular auction item is placed for bid and the bidder registration fee may be automatically transferred to that auction. The process 400, however, determines at step 324 if there are more bidders to notify and, if so, returns to step 316. Otherwise, the process 400 ends.

FIG. 4 illustrates the process 400 performed by the processor 40 executing respective programming instructions related to operation of an auction once the auction has been set up and the pool filled with bidders. Steps 402 and 404 reflect that the auction has begun and bids are received. At step 406, the processor 40 determines if the previously set time period for the auction has expired and, if not, the process 400 continues to receive bids. If, however, the auction time is determined to have expired, then the auction is closed, no more bids are received, and the process 400 proceeds to step 408. It is understood that the computer's processor 40 is in communication with the timer 50 for determining if an auction time has expired. At step 408, the processor 40 determines which received bid is the highest bid and declares the highest bid to be the “winning bid.” The process 400 then proceeds to step 410 at which the processor 40 directs a notice be sent to the highest bidder that his or her bid is the winning bid and the process 400 proceeds to step 412. It is understood that this notice is preferably by electronic mail but may also be by telephone. At step 412, the processor 40 determines if the highest bidder, i.e. the winner, has responded within a predetermined amount of time and, if not, proceeds to step 416. At step 416, the processor 40 determines if a predetermined time to respond has expired and, if not, proceeds again to step 414. If at step 416, the processor 40 determines that the time for the winning bidder to respond has expired, then the process 400 proceeds to step 412. At step 412, the processor 40 determines the next highest bidder and declares that bid to be the winning bid. The process 400 then proceeds again to step 410 for notification of the new winning bidder.

If the winning bidder responds within the predetermined response time at steps 414 and 416, the process 400 proceeds to step 418. At step 418, the winning bidder must pay the winning bid price to the auction system, such as by credit card, debit card, Pay-Pal® or the like. After payment is made, the process 400 proceeds to step 420. At step 420, the winning bidder is presented with the opportunity to spin a random number selection device, such as a roulette wheel. The random number selection device may be a virtual roulette wheel displayed on the winning bidder's computer display or may be an actual physical roulette wheel at a physical location to which the winning bidder may travel—such as at the set of a reality television show or the site of the auction headquarters. Alternatively, the random number selection device may be a digital number generating program with or without a graphical user interface (GUI). In any case, the numbers available to the random number generator are numbers within the boundaries of the rebate number data first set by the administrator for the respective auction. For instance, if the range of rebates was between 25% and 100%, then the roulette wheel would include some or all whole numbers in that range. After a rebate is selected by the winning bidder, the process 400 proceeds to step 422 wherein the rebate percentage is actually assigned and a rebate amount is calculated.

At step 424, the process 400 executes program instructions to direct that the awarded auction item be shipped to the winning bidder. This may include automatically making shipping arrangements according to the bidder's contact information or sending a message to appropriate personnel that it is time to make the shipment. After the auction item has been shipped, the process 400 proceeds to step 426 where the rebate is paid to the winning bidder. This step may include crediting a bank account, crediting a credit card, crediting a Pay-Pal® account, or directing a check to be issued and mailed. Thereafter, the auction is ended at step 428.

It is understood that the steps relating to the winning bidder paying the entire winning price, selection of a rebate, shipment of the auction item, and payment of the rebate may be taken in a different order, although the order described above is preferred.

In use, the system 100 described above may be used to generate extraordinary profit to the auction service and/or administrator while at the same time providing an extraordinary rebate to a winning bidder at a relatively low perceived risk to each participating bidder. The following is a hypothetical example and assumes the following parameters and participation:

pool size: 500

participation fee: $30

cost of auction item: $15,000

highest bid (winner): $12,000

random rebate given: 50%

Operation of this hypothetical example would result in the following results:

| | | |
|---|---|---|
| Revenue from bidder registrations: | $15,000 | |
| Revenue from selling auction item: | $12,000 | (highest bid) |
| Total Revenue | $27,000 | |
| Cost of auction item: | —$15,000 | |
| Rebate Awarded (randomly) | —$6,000 | (50% of winning bid) |
| Total Cost to Auction Service | —$21,000 | |
| Net Gain (Profit) | $6,000 | |

Accordingly, operation of the online auction system with assignment of a random rebate to the winning bid results in a favorable return to the seller (i.e. auction provider) even when a substantial rebate is given so long as the number of registered bidders and requisite bidder participation fee are appropriately managed. Specifically, the amount of the bidder registration fee may be adjusted higher or lower depending on the value of the auction item and the number of bidders to be allowed into the pool. Similarly, bidders may be more willing to pay a higher fee and take an increased risk of loss if the number of bidders in the pool is kept low, thus increasing the odds of winning. In other instances, a relatively low value auction item and low participation fee may draw a very large pool of participants in a short time in that the risk of loss is very low. In any case, the administrator of the online auction according to the present invention will learn to optimize his profit by efficiently managing the setting of parameters and accounting for the risk of a high rebate percentage being selected by the computer.

It is understood that while certain forms of this invention have been illustrated and described, it is not limited thereto except insofar as such limitations are included in the following claims and allowable functional equivalents thereof.

What is claimed is:

1. An online auction system with a random winner rebate for operation by an administrator to manage operation of an online auction, comprising:
a computer electrically connected to a computer network, said computer having a memory configured to store programming and data structures;
a processor electrically connected to said computer and to said memory configured to execute said programming;
wherein said computer includes an input in data communication with said processor and configured to receive instructions from an auction administrator;
programming in said memory that when executed by said processor:
receives auction item data from said input and stores said auction item data in said memory;
receives rebate range data from said input and stores said rebate range data in said memory;
receives pool closure time data from said input and stores said pool closure time data in said memory;
receives auction time data from said input and stores said auction time data in said memory;
receives predetermined fee data from said input and stores said predetermined fee data in said memory;
receives bidder registration data from said computer network until expiration of a time associated with said pool closure time data, said bidder registration data including contact information and payment of an auction fee according to said predetermined fee data;
receives bids from registered bidders relative to said auction item data until expiration of a time associated with said auction time data;
programming in said memory that when executed by said processor determines a highest bid from said received bids upon expiration of said time associated with said auction time data and determines said highest bid to be a winning bid; and
programming in said memory that when executed by said processor randomly determines a winning rebate taken from said rebate range data.

2. The online auction system as in claim 1, wherein:
said computer is a network server in data communication with remote computers connected to the internet;
said auction item data includes an auction item identifier, auction item description, an auction item picture, and an auction item cost.

3. The online auction system as in claim 1, further comprising:
programming in said memory that when executed by said processor notifies a winning bidder associated with said winning bid that said highest bid is a winning bid;
programming in said memory that when executed by said processor that waits a predetermined amount of time for said winning bidder to respond to said notification;
programming in said memory that when executed by said processor determines if said winning bidder has not responded within said predetermined response time and, if not, determines a next highest bid from said received bids and declares said next highest bid to be said winning bid.

4. The online auction system as in claim 1, further comprising:
programming in said memory that when executed by said processor calculates a rebate by multiplying said winning bid times said winning rebate; and
programming in said memory that when executed by said processor monitors if said winning bid has been received by said administrator;
programming in said memory that when executed by said processor directs payment of said rebate to said winning bidder only when said winning bid has been received by said administrator.

5. The online auction system as in claim 1, further comprising:
programming in said memory that when executed by said processor monitors if said winning bid has been received from said winning bidder;
programming in said memory that when executed by said processor determines a winning rebate taken from said rebate range data only after said winning bid has been received by said administrator from said winning bidder.

6. The online auction system as in claim 1, further comprising:
programming in said memory that when executed by said processor monitors if said winning bid has been received from said winning bidder;
programming in said memory that when executed by said processor determines a winning rebate percentage taken from said rebate range data only after said winning bid has been received;
programming in said memory that when executed by said processor calculates a rebate by multiplying said winning bid times said winning rebate percentage; and
programming in said memory that when executed by said processor directs payment of said rebate to said winning bidder only when said winning bid has been received from said winning bidder.

7. The online auction system as in claim 1, further comprising:
programming in said memory that when executed by said processor determines said winning rebate when said winning bidder actuates a random number selection device; and
wherein said random number selection device is propagated with numbers from rebate range data.

8. The online auction system as in claim 7 wherein said random number selection device includes one of a roulette wheel and a virtual roulette wheel.

9. The online auction system as in claim 1, further comprising programming in said memory that when executed by said processor directs an auction item associated with said auction item identifier to be shipped to said winning bidder only after said winning bid has been received from said winning bidder.

10. The online auction system as in claim 1, further comprising:
programming in said memory that when executed by said processor receives pool minimum size data from said input and stores said pool minimum size data in said memory;
programming in said memory that when executed by said processor determines if said pool minimum size data is indicative of being full and, if so, directs an online auction to begin.

11. The online auction system as in claim 10, further comprising:
programming in said memory that when executed by said processor determines whether said closure time data is indicative of expiration of time to receive bidder registration data;
programming in said memory that when executed by said processor notifies said administrator if both said pool minimum size data is indicative of not being full and said closure time data is indicative of expiration.

12. The online auction system as in claim 11, further comprising:
programming in said memory that when executed by said processor receives unfilled pool data from said input;
programming in said memory that when executed by said processor directs an auction to begin if said unfilled pool data is indicative of said administrator desiring to proceed to auction with an unfilled pool;
programming in said memory that when executed by said processor increases said pool closure time if said unfilled pool data is indicative of said administrator's desire to keep the pool open for a longer period of time; and
programming in said memory that when executed by said processor notifies each registered bidder that a respective registration will be held over to a later auction if said unfilled pool data is indicative of said administrator's desire to cancel a current auction in favor of a subsequent auction.

13. The online auction system as in claim 12, further comprising programming in said memory that when executed by said processor directs a refund to be issued to a registered bidder if said registered bidder indicates a desire to receive a refund instead of holding over to said later auction.

14. The online auction system as in claim 1, wherein said computer includes a timer electrically connected to said processor that, when actuated, is configured to determine an expiration of said pool closure time data and said auction time data.
